(19) United States
(12) Patent Application Publication
(10) Pub. No.: US 2026/0343541 A1
(43) Pub. Date: Oct. 29, 2026

(54) TECHNIQUES FOR MULTI-USER MULTIPLE-INPUT MULTIPLE-OUTPUT COMMUNICATIONS WITH CO-SCHEDULING PARAMETER INDICATION

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Navid ABEDINI, Basking Ridge, NJ (US); Junyi LI, Greentown, PA (US); Tao LUO, San Diego, CA (US)

(21) Appl. No.: 19/193,734

(22) Filed: Apr. 29, 2025

(51) Int. Cl. H04W 72/1273; H04B 7/0452; H04L 5/00; H04W 72/232

(52) U.S. Cl. CPC H04W 72/1273; H04B 7/0452; H04L 5/005; H04W 72/232

(57) ABSTRACT

This disclosure provides methods, components, devices and systems for techniques for multi-user multiple-input multiple-output (MU-MIMO) communications with co-scheduling parameter indication. For example, a user equipment (UE) may be indicated with MU-MIMO co-scheduling information for one or more resource units that include time domain resources, frequency domain resources, and spatial domain resources that are co-scheduled for two or more UEs. For example, for each resource unit, the co-scheduling information may include one or more of a modulation order, one or more reference signal ports or groups of ports, a reference signal sequence initialization of a co-scheduled transmission, or any combination thereof. A UE that receives co-scheduling information for one or more resource units that overlap with resources of a scheduled communication may perform joint demodulation using both the parameters of the scheduled communication and the co-scheduled information, to enhance demodulation and decoding efficiency.

### TECHNICAL FIELD

This disclosure relates generally to wireless communication, and more specifically to systems, devices, methods, and techniques associated with techniques for multi-user multiple-input multiple-output communications with co-scheduling parameter indication.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a first UE is described. The method may include receiving co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a multi-user multiple-input multiple-output (MU-MIMO) communication scheduled on at least the first resource unit and receiving at least a portion of the first downlink transmission based on a first set of transmission parameters of the first downlink transmission and the second set of transmission parameters indicated by the co-scheduling information for the first resource unit.

A first UE for wireless communications is described. The first UE may include a processing system that includes processor circuitry and memory circuitry that stores code. The processing system may be configured to cause the first UE to receive co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and receive at least a portion of the first downlink transmission based on a first set of transmission parameters of the first downlink transmission and the second set of transmission parameters indicated by the co-scheduling information for the first resource unit.

Another first UE for wireless communications is described. The first UE may include means for receiving co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and means for receiving at least a portion of the first downlink transmission based on a first set of transmission parameters of the first downlink transmission and the second set of transmission parameters indicated by the co-scheduling information for the first resource unit.

A non-transitory computer-readable medium storing code for wireless communications is described. The code may include instructions executable by one or more processors to receive co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and receive at least a portion of the first downlink transmission based on a first set of transmission parameters of the first downlink transmission and the second set of transmission parameters indicated by the co-scheduling information for the first resource unit.

In some examples of the method, first UEs, and non-transitory computer-readable medium described herein, receiving at least the portion of the first downlink transmission may include operations, features, means, or instructions for jointly demodulating the first downlink transmission in accordance with the first set of transmission parameters and the second set of transmission parameters, where the first set of transmission parameters is provided in a scheduling DCI transmission provided to the first UE.

In some examples of the method, first UEs, and non-transitory computer-readable medium described herein, the frequency domain resources include one or more of physical resource block (PRB) resources, PRB group resources, or frequency sub-band resources. In some examples of the method, first UEs, and non-transitory computer-readable medium described herein, the time domain resources include one or more orthogonal frequency division multiplexing (OFDM) symbols, a set of OFDM symbols, or one or more slots, or any combination thereof. In some examples of the method, first UEs, and non-transitory computer-readable medium described herein, the spatial domain resources include one or more co-scheduled spatial layers, one or more groups of co-scheduled spatial layers, or any combination thereof.

In some examples of the method, first UEs, and non-transitory computer-readable medium described herein, the second set of transmission parameters indicated by the co-scheduling information include one or more of a modulation order, one or more DMRS ports, one or more code division multiplexing (CDM) groups of DMRS ports, DMRS sequence initialization information, or any combination thereof.

In some examples of the method, first UEs, and non-transitory computer-readable medium described herein, the co-scheduling information may be received via one or more of RRC signaling, a medium access control (MAC) control element (CE), a non-scheduling unicast DCI transmission, a group common DCI transmission, or a scheduling DCI.

Some examples of the method, first UEs, and non-transitory computer-readable medium described herein may further include operations, features, means, or instructions for transmitting capability information that indicates a capability of the first UE to jointly demodulate downlink transmissions in accordance with co-scheduling information.

A method for wireless communications by a network entity is described. The method may include transmitting, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and transmitting, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters.

A network entity for wireless communications is described. The network entity may include a processing system that includes processor circuitry and memory circuitry that stores code. The processing system may be configured to cause the network entity to transmit, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and transmit, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters.

Another network entity for wireless communications is described. The network entity may include means for transmitting, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and means for transmitting, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters.

A non-transitory computer-readable medium storing code for wireless communications is described. The code may include instructions executable by one or more processors to transmit, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit and transmit, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters.

Some examples of the method, network entities, and non-transitory computer-readable medium described herein may further include operations, features, means, or instructions for transmitting, to the first UE, a scheduling DCI transmission that indicates the first set of transmission parameters. In some examples of the method, network entities, and non-transitory computer-readable medium described herein, the frequency domain resources include one or more of PRB resources, PRB group resources, or frequency sub-band resources. In some examples of the method, network entities, and non-transitory computer-readable medium described herein, the time domain resources include one or more OFDM symbols, a set of OFDM symbols, or one or more slots, or any combination thereof. In some examples of the method, network entities, and non-transitory computer-readable medium described herein, the spatial domain resources include one or more co-scheduled spatial layers, one or more groups of co-scheduled spatial layers, or any combination thereof. In some examples of the method, network entities, and non-transitory computer-readable medium described herein, the second set of transmission parameters indicated by the co-scheduling information include one or more of a modulation order, one or more DMRS ports, one or more CDM groups of DMRS ports, DMRS sequence initialization information, or any combination thereof.

In some examples of the method, network entities, and non-transitory computer-readable medium described herein, the co-scheduling information may be transmitted via one or more of RRC signaling, a MAC-CE, a non-scheduling unicast DCI transmission, a group common DCI transmission, or a scheduling DCI.

Some examples of the method, network entities, and non-transitory computer-readable medium described herein may further include operations, features, means, or instructions for receiving, from the first UE, capability information that indicates a capability of the first UE to jointly demodulate downlink transmissions in accordance with co-scheduling information.

### BRIEF DESCRIPTION OF THE DRAWINGS

FIG. 1 shows an example of a wireless communication system.

FIG. 2 shows an example of a signaling configuration that supports techniques for multi-user multiple-input multiple-output (MU-MIMO) communications with co-scheduling parameter indication.

FIG. 3 shows an example of resource units that support techniques for MU-MIMO communications with co-scheduling parameter indication.

FIG. 4 shows an example of a process flow that supports techniques for MU-MIMO communications with co-scheduling parameter indication.

FIG. 5 shows a block diagram of a processing system that supports techniques for MU-MIMO communications with co-scheduling parameter indication.

FIG. 6 shows a diagram of a system including a device that supports techniques for MU-MIMO communications with co-scheduling parameter indication.

FIG. 7 shows a block diagram of a processing system that supports techniques for MU-MIMO communications with co-scheduling parameter indication.

FIG. 8 shows a diagram of a system including a device that supports techniques for MU-MIMO communications with co-scheduling parameter indication.

FIGS. 9 through 12 show flowcharts illustrating methods that support techniques for MU-MIMO communications with co-scheduling parameter indication.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, multi-user (MU) multiple-input multiple-output (MIMO) communications to provide concurrent communications with multiple user equipments (UEs). MU-MIMO communications may use beamforming techniques to create narrow, high-gain beams that focus the signal towards specific UEs and provide concurrent communications with multiple UEs using the same time, frequency, and/or spatial resources, which may enhance throughput and a quantity of UEs that can be supported by a network entity (e.g., a base station, gNB, radio head, etc.). In some cases, when two UEs are scheduled for concurrent communications in accordance with MU-MIMO techniques, transmissions to a first UE may experience some interference from transmissions to a second UE that may reduce decoding efficiency of the first UE, the second UE, or both. In some deployments, a UE may be indicated with co-scheduling information that may allow for joint demodulation (e.g., using reduced complexity maximum likelihood demodulation at a UE for enhanced inter-user interference suppression for MU-MIMO transmissions). For example, some techniques may provide a set of bits (e.g., 3 bits) in a scheduling downlink control information (DCI) transmission that may indicate co-scheduling of the first UE and the second UE. However, such techniques provide a coarse granularity (e.g., indicates whether or not a co-scheduled UE is present on resources allocated to the first UE, and a modulation scheme of one or more co-scheduled UEs), where a root demodulation reference signal (DMRS) sequence of the co-scheduled layers has to be the same as the root DMRS sequence of the first UE. Thus, techniques for indication of additional granularity of co-scheduling information may be desirable.

Aspects of the subject matter described in this disclosure relate to MU-MIMO communications in which a UE may be indicated with co-scheduling information for one or more resource units that include time domain resources, frequency domain resources, and spatial domain resources that are co-scheduled for two or more UEs. For example, co-scheduling information may be provided for resource units that include resources in the frequency domain, the time domain, and per spatial layer or group of spatial layers of each co-scheduled layer or group of layers (e.g., where a group can be defined as code division multiplexing (CDM) group of co-scheduled layers). In some aspects, for each resource unit, (e.g., for each frequency/time/spatial unit), the co-scheduling information may include one or more of a modulation order, one or more DMRS ports or CDM groups of DMRS ports, a DMRS sequence initialization of the co-scheduled transmission, or any combination thereof. A UE that receives co-scheduling information for one or more resource units that overlap with resources of a scheduled communication (e.g., a scheduled physical downlink shared channel (PDSCH) transmission) may perform joint demodulation using both the parameters of the scheduled communication and the co-scheduled information, to enhance the likelihood of successfully demodulation and decoding the scheduled communication.

In some aspects, for each resource unit, the co-scheduling information may indicate, for a co-scheduled transmission on the resource unit, a modulation order, a DMRS port or CDM group, an identification of a DMRS sequence, or any combination thereof. In some aspects, the co-scheduling information may be provided via radio resource control (RRC) signaling, a medium access control (MAC) control element (CE), a non-scheduling unicast DCI, a group common (GC) DCI, a scheduling DCI that schedules a PDSCH of a UE, or any combination thereof. Additionally, or alternatively, a UE may provide capability indication to a network entity associated with co-scheduling information. For example, a UE may indicate supported parameters, such as an upper limit of co-scheduled layers on the scheduled PDSCH, an upper limit of subbands (or frequency units), an upper limit of symbol groups (or time units), an upper limit of groups of layers (or spatial units) that can have different co-scheduled information for a given PDSCH, whether a root DMRS sequence of co-scheduled layers can be different than the DMRS sequence of a scheduled PDSCH for the UE, an upper limit of a modulation order of a co-scheduled layer, or any combination thereof.

Particular aspects of the subject matter described in this disclosure can be implemented to realize one or more of the following potential advantages. In some examples, by providing co-scheduling information for one or more resource units, the described techniques can be used to enable joint demodulation at a UE for co-scheduled MU-MIMO communications and thereby enhance demodulation and decoding efficiency at the UE. In some examples, by providing co-scheduling information for resource units that include resources in the frequency domain, the time domain, and the spatial domain, the described techniques can be used to provide flexible MU-MIMO scheduling that may enhance network efficiency and throughput while also providing for more reliable demodulation of communications at UEs. In some examples, by providing co-scheduling information via RRC signaling, one or more MAC-CEs, and/or one or more DCIs, the described techniques can be used to flexibly indicate co-scheduling parameters based on particular traffic conditions that may be efficiently enabled and updated. Further, in some examples, by providing UE capability information, the described techniques can be used to efficiently configure UEs in accordance with their associated capabilities.

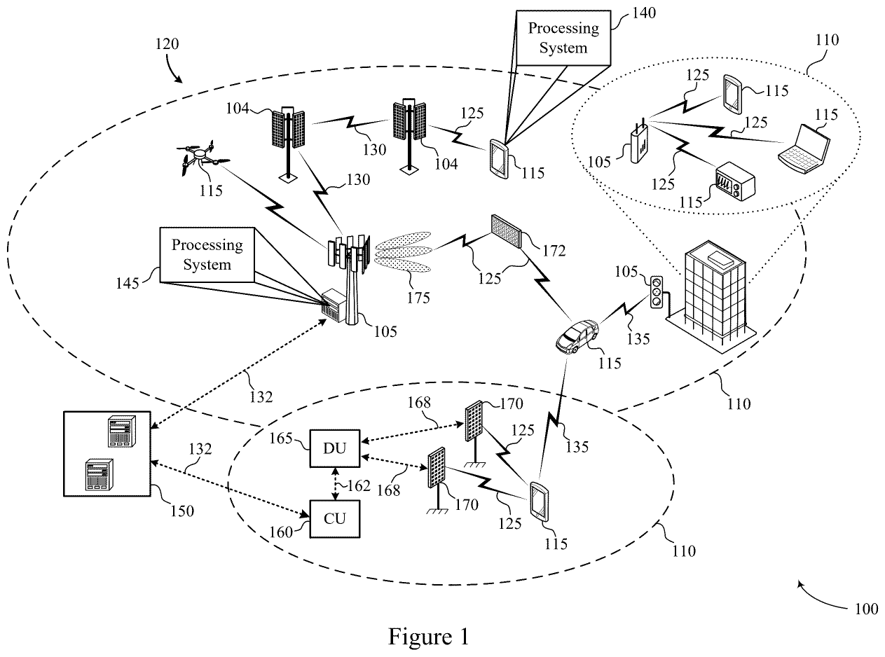

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for techniques for MU-MIMO communications with co-scheduling parameter indication. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support providing co-scheduling information for one or more resource units, which can be used to enable joint demodulation at a UE for co-scheduled MU-MIMO communications and thereby enhance demodulation and decoding efficiency at the UE while enhancing network efficiency.

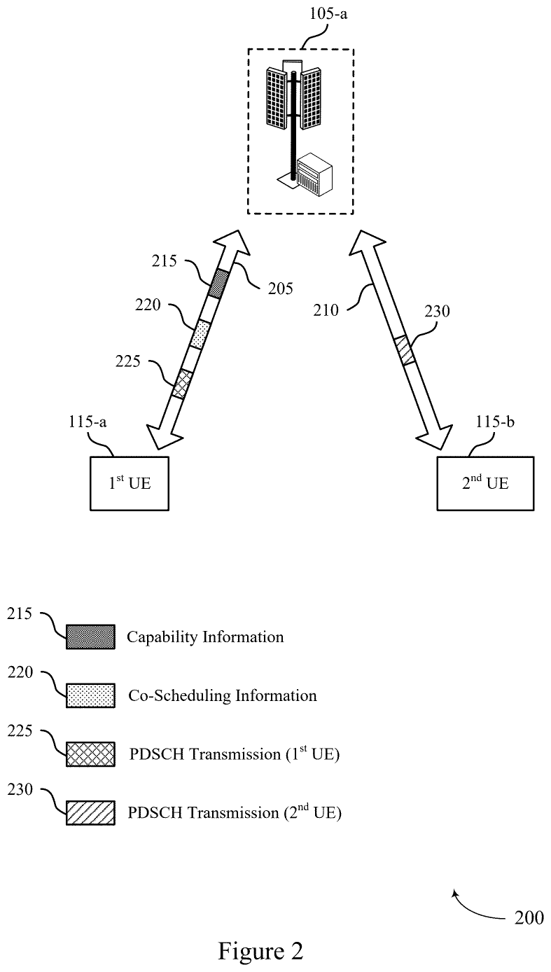

FIG. 2 shows an example of a signaling configuration 200 that supports techniques for MU-MIMO communications with co-scheduling parameter indication. In some examples, signaling configuration 200 may implement aspects of wireless communications system 100. In the example of FIG. 2, signaling configuration 200 may include a network entity 105-a, a first UE 115-a, and a second UE 115-b. The network entity 105-a, first UE 115-a, and second UE 115-b may be examples of the corresponding devices described with respect to FIG. 1.

In accordance with various aspects, the first UE 115-a may establish a first link with the network entity 105-a via a first connection 205 (e.g., a connection via a Uu interface), and the second UE 115-b may establish a second connection 210 with the network entity 105-a (e.g., a connection via a Uu interface). In some examples, as discussed herein, the network entity 105-a may use MU-MIMO techniques for communications with the first UE 115-a, the second UE 115-b, and optionally one or more other UEs. In some aspects, the first UE 115-a may transmit capability information 215 to the network entity 105-a that indicates one or more capabilities of the first UE 115-a related to processing of co-scheduled communications in MU-MIMO communications. In some aspects, based on capabilities of the first UE 115-a, the network entity 105-a may transmit co-scheduling information 220 to the first UE 115-a, and may transmit a first PDSCH transmission 225 to the first UE 115-a while transmitting a second PDSCH transmission 230 to the second UE 115-b in accordance with MU-MIMO techniques.

As discussed herein, some traditional systems may provide relatively coarse co-scheduling information for MIMO communications, such as an indication of whether co-scheduled communications are present and a modulation scheme for the co-scheduled communications, where a root DMRS sequence of the co-scheduled layers has to be the same for each UE. Such coarse indications could not indicate various co-scheduling parameters, such as modulation orders for different frequency subbands (or other frequency domain resources), different symbols (or other time domain resources), or co-scheduled layers (or other spatial domain resources). Further, a quantity and accumulated traffic by fixed wireless access or customer premises equipment (FWA/CPE) devices is increasing, and such devices may have additional capabilities compared to other types of UEs (e.g., due to a larger form factor, increased processing capabilities, reduced power constraints, and the like). Additionally, such devices may have fixed locations and have slow-varying changes to channel conditions. Further, MU-MIMO pairing across two or more FWA/CPE UEs may not need to change very often, and scheduling information (e.g., MCS/number of spatial layers) for each FWA/CPE UE may be consistent across multiple slots. Various techniques discussed herein can thus provide co-scheduled information for DL MU-MIMO to UEs (e.g., FWA/CPE UEs, or other types of UEs), which may be relatively slow time-varying information such that RRC or MAC signaling may be used to indicate one or more parameters. Further, for example due to bursty traffic, a presence or absence of co-scheduled layers may be provided in more dynamic signaling, such as DCI.

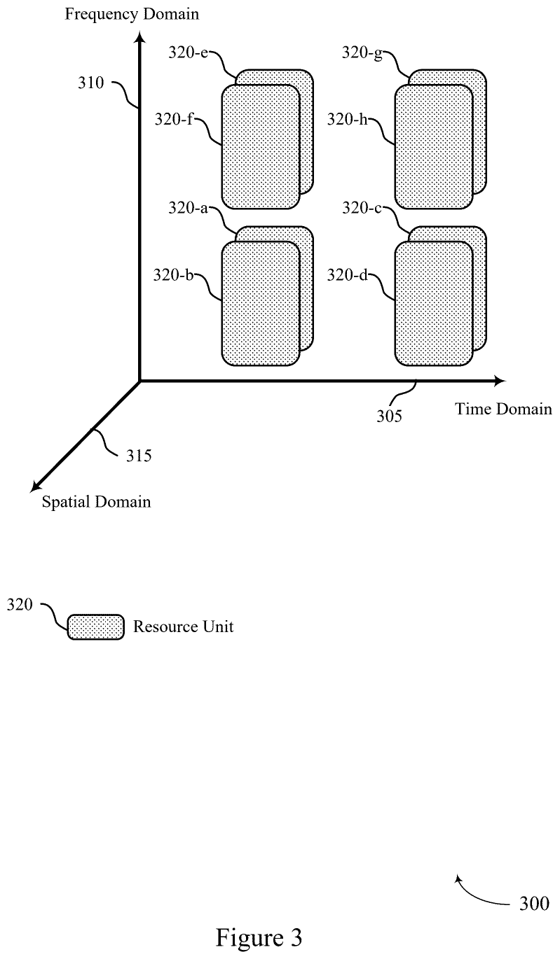

In some aspects, the first UE 115-a may be indicated with co-scheduling information 220, which may be provided per resource unit for multiple configured resource units. In some aspects, each resource unit may include frequency domain resources (e.g., frequency resources per PRB, per physical resource group (PRG), or per subband), time domain resources (e.g., per OFDM symbol, per set of OFDM symbols, per slot, where a set of OFDM symbols can be with respect to a set of symbols separated based on DMRS symbol locations), spatial domain resources (e.g., per spatial layer of each co-scheduled layer, or per group of layers of the co-scheduled layers, where a group may be a CDM group of co-scheduled layers), or any combination thereof. FIG. 3 shows an example of resource units in accordance with various aspects. In some aspects, for each resource unit, the co-scheduling information 220 may include, for example, a modulation order of the co-scheduled communications, one or more DMRS ports or CDM groups of DMRS ports of the of the co-scheduled communications (in some cases this may not be needed if the spatial domain definition of resource unit provides per co-scheduled layer (DMRS port) or per group of co-scheduled layers (CDM group)), a DMRS sequence initialization (e.g., c_init) that can be indicated via scrambling ID (and possibly CDM group of associated DMRS port) of the co-scheduled communications, or any combination thereof. In some aspects, the first UE 115-a, upon being scheduled with first PDSCH transmission 225 (e.g., in a scheduling DCI), may perform joint demodulation using both the parameters of the scheduled first PDSCH transmission 225 and the co-scheduling information 220 associated with the second PDSCH transmission 230.

In some aspects, all or a portion of the co-scheduling information 220 may be provided via one or more of RRC signaling, one or more MAC-CEs, one or more DCI transmissions, or any combination thereof. In some cases, all or a portion of co-scheduling information 220 may be provided in a MAC-CE, and such an indication may be “sticky,” and applied at a given time (e.g., 3 ms) after an acknowledgement of a PDSCH transmission that contains the MAC-CE. In some cases, one or more non-scheduling unicast DCI transmissions may provide all or a portion of the co-scheduling information 220 (e.g., a DCI without scheduling information for a PDSCH but with associated acknowledgment feedback). In some aspects, co-scheduling information 220 provided in a non-scheduling unicast DCI may be applied a given time (e.g., X symbols) after an acknowledgment transmission associated with the DCI, where X can be based on UE capability, RRC configuration, or both. In some aspects, some or all of the co-scheduling information 220 may be provided in a group-common DCI (e.g., a DCI with a cyclic redundancy check (CRC) scrambled with a RRC-configured group-common radio network temporary identifier (RNTI)) in a common search space (CSS). In some cases, an indication via GC-DCI may be specific to a time window (e.g., aligned with a periodicity of the CSS for monitoring this DCI format). Further, in some aspects, all or a portion of the co-scheduling information 220 may be provided in a scheduling DCI (e.g., a DCI that schedules the first PDSCH transmission 225). Such an indication via a scheduling DCI may be non-sticky and only applicable to the scheduled PDSCH.

As discussed, in some cases different types of signaling may be used to provide different portions of the co-scheduling information 220. For example, RRC signaling may configure one or more resource units in the frequency, time, and spatial domains. For example, RRC may configure a subband size, number of subbands in the frequency domain (e.g., 2 subbands), or associated resource blocks that belong to each subband, a number of slots or time periodicity that the same co-scheduled info may be repeated (e.g., 5 slots), and a time offset (e.g., slot offset) that determines the starting time (e.g., starting slot) of a period, a limit of a number of layers in the spatial domain for co-scheduled layers (e.g., 8 layers), and the granularity of indication with respect to the number of layers (e.g., 4 layers for a resource unit in spatial domain, resulting in 2 groups of co-scheduled layers or spatial domain resource units). Such configuration results in defining a number of resource units in frequency, time, and spatial domain (e.g., 2*5*2=20 overall resource units in frequency, time, and spatial domain). In such an example, a MAC-CE may indicate one or more transmission parameters of a set to transmission parameters for the co-scheduling information 220 (e.g., a modulation order, DMRS parameters) for each of the resource units. For example, such information may be provided in one or more MAC-CEs for each of the 20 resource units in this example. Alternatively, such parameters may be provided in RRC signaling, or may be provided by one or more non-scheduling DCI transmissions. Continuing with this example, a scheduling DCI may indicate a presence or absence of co-scheduled layers for the first PDSCH transmission 225 on a subset of resource units of the second PDSCH transmission 230 that overlap (e.g., in frequency and time) with the first PDSCH transmission 225. For example, for a PDSCH slot, 4 bits in the scheduling DCI may be used to indicate a presence or absence of the co-scheduled layers on four resource units (2 in frequency domain and 2 in spatial domain). Alternatively, such an indication may be provided by GC-DCI for a time window associated with a CSS, or may be provided by MAC-CE. In some aspects, providing a dynamic indication of a presence or absence of co-scheduled layers, may provide flexibility for dynamic or bursty traffic patterns (e.g., while multiple user (MU) grouping is not dynamic, a subset of co-scheduled UEs may not have downlink data to schedule in each downlink transmission instance).

In another example, RRC and MAC-CE, or both may be used to configure multiple candidate sets of co-scheduled profiles. For example, each candidate profile may contain the co-scheduling information 220 for one or more resource units (e.g., which can be also part of the profile). Further, some of the scheduling information for the first UE 115-a (e.g., for a target PDSCH such as first PDSCH transmission 225; different than co-scheduled information) may be part of the candidate profile configurations (e.g., the scheduling information for a target PDSCH may include a number of layers, DMRS ports, modulation and coding scheme (MCS), and time-frequency resources). In this example, a scheduling DCI may indicate one of the configured profiles for the scheduled PDSCH. In some cases, an indication in the scheduling DCI may include one possibility that is reserved to indicate no co-scheduling (e.g., if N candidate profiles are configured a quantity of ceil (log 2(N+1)) bits may be included in the scheduling DCI to indicate which profile or that no co-scheduling is present). Such techniques may allow the network entity 105-a to flexibly co-schedule UEs 115 (e.g., schedule UE-A and UE-B, schedule UE-B and UE-C, or schedule UE-C and UE-A, which provides two possibilities for co-scheduled information for UE-A depending on if it is co-scheduled with UE-B or UE-C). In some cases, the scheduling information also may be included in candidate profiles, which may allow the network entity 105-a to flexibly choose, from the UE-A point of view, one of the following profiles {A alone, A&B, A&C, A&B&C}, where the scheduling information (e.g., rank or MCS) for UE-A itself (e.g., target PDSCH) is dependent on co-scheduled information (and thus efficiency is enhanced by defining scheduling information also as part of the candidate profiles). In some cases, if the network entity 105-a intends to have different MU-MIMO pairing for initial transmissions versus retransmissions, such techniques may provide for defining associated candidate profiles and dynamically indicating one by the scheduling DCI.

In some aspects, as discussed, the first UE 115-a may provide capability information 215 related to co-scheduling in MU-MIMO. In some cases, one or more of the following may be indicated by the capability information 215: an upper limit of a quantity of co-scheduled layers on the scheduled PDSCH; an upper limit of a quantity of subbands (or frequency units), symbol groups (or time units), or groups of layers (spatial units), that can have different co-scheduled information for a given PDSCH; whether a root DMRS sequence of co-scheduled layers can be different than the DMRS sequence of the targeted PDSCH (e.g., and if so, how many different root DMRS sequences for different co-scheduled layers are supported); an upper limit of a modulation order of a co-scheduled layer (e.g., which may also be dependent on the number of layers or modulation order of the scheduled PDSCH). For example, the first UE 115-a may indicate one or more combinations in the form of (max mod order of PDSCH, max rank of PDSCH, max mod order of co-scheduled layers, max number of layers of co-scheduled layers (e.g., the first UE 115-a may support {(10,4,8,2), (8,4,10,4)} but not (10,4,10,4)).

FIG. 3 shows an example of a resource units 300 that supports techniques for MU-MIMO communications with co-scheduling parameter indication. In some examples, the resource units 300 may be implemented by aspects of wireless communications system 100 or signaling configuration 200, as described with reference to FIGS. 1 and 2, or by a UE and one or more network entities as discussed with reference to FIGS. 1 and 2.

In this example, eight resource units 320 are illustrated, including a first resource unit 320-a through an eighth resource unit 320-h. Each resource unit has associated time domain 305 resources, frequency domain 310 resources, and spatial domain 315 resources. In some aspects, time domain 305 resources may include one or more OFDM symbols, one or more sets of OFDM symbols (e.g., where a set of OFDM symbols can be with respect to a set of symbols separated based on DMRS symbol locations), or one or more slots. In some aspects, frequency domain 310 resources may include one or more PRBs or portions of one or more PRBs, one or more PRGs, one or more frequency subbands, or one or more bandwidth parts (BWPs). In some aspects, spatial domain 315 resources may include one or more spatial layers, or one or more groups of spatial layers (e.g., where a group may be a CDM group of co-scheduled layers). In some aspects, for each resource unit 320, a UE may be indicated with co-scheduling information as discussed herein, such as an associated modulation order, an associated DMRS port or CDM group, a parameter to identify an associated DMRS sequence, or any combination thereof.

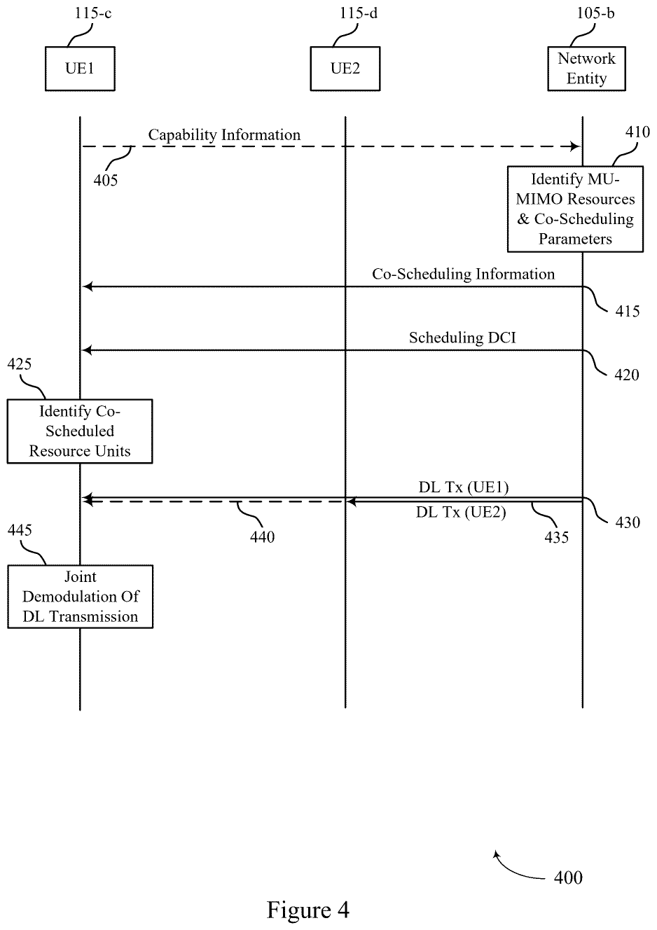

FIG. 4 shows an example of a process flow 400 that supports techniques for MU-MIMO communications with co-scheduling parameter indication. The process flow 400 may include a network entity 105-b that provides access to a RAN, a first UE 115-c, and a second UE 115-d, which may be examples of corresponding devices as described with reference to FIGS. 1 through 3. In some cases, the process flow 400 may be implemented by the network entity 105-b and the UEs 115 when MU-MIMO is configured and the first UE 115-c indicates support for one or more co-scheduling parameters in MU-MIMO. Such techniques may provide enhanced MU-MIMO communications with more efficient joint demodulation based on specific co-scheduling parameters associated with a downlink transmission, which may thereby enhance overall network efficiency, reduce power consumption, and enhance user experience. In the following description of the process flow 400, the operations between the network entity 105-b and UEs 115 may be performed in a different order than the example order shown. Some operations may be omitted from the process flow 400, and other operations may be added to the process flow 400.

Optionally, at 405, the first UE 115-c may transmit, and the network entity 105-b may receive, a capability information message. The capability information message may indicate capabilities of the first UE 115-c for demodulating co-scheduled communications in accordance with co-scheduling parameters, in accordance with techniques as discussed with reference to FIGS. 2 and 3. In some cases, the capability information message may be provided via RRC signaling, such as during a connection establishment or reestablishment procedure.

At 410, the network entity 105-b may identify MU-MIMO resource units and co-scheduling parameters in accordance with techniques as discussed with reference to FIGS. 2 and 3. For example, based on the capabilities of the first UE 115-c, the network entity 105-b may determine a first set of co-scheduling parameters (e.g., a quantity of resource units that can be co-scheduled, a modulation order associated with each resource unit, an associated DMRS port or CDM group associated with each resource unit, and/or a parameter to identify an associated DMRS sequence associated with each resource unit). At 415, the network entity 105-b may transmit, and the first UE 115-c may receive, the co-scheduling information. As discussed herein, the co-scheduling information may be transmitted via RRC signaling, one or more MAC-CEs, one or more DCI transmissions, or any combination thereof.

At 420, the network entity 105-b may transmit, and the first UE 115-c may receive, a scheduling DCI. The scheduling DCI may include a resource allocation for a PDSCH transmission for the first UE 115-c, as discussed herein. In some aspects, as discussed herein, the scheduling DCI may also include a portion of the co-scheduling information, such as an indication of whether co-scheduling is present for any resource units that overlap with the allocated resources of the PDSCH transmission, or a selected set of co-scheduling parameters associated with the PDSCH transmission (e.g., based on one or more transmission parameters of a concurrent MU-MIMO transmission to the second UE 115-d that uses resource that overlap with one or more of the resource units). At 425, the first UE 115-c may identify one or more co-scheduled resource units, in accordance with techniques as discussed with reference to FIGS. 2 and 3.

At 430, the network entity 105-b may transmit, and the first UE 115-c may receive, a first downlink transmission. Additionally, at 435, the network entity 105-b may transmit, and the second UE 115-d may receive, a second downlink transmission, where the second downlink transmission has one or more overlapping resource units with the first downlink transmission. At 440, the second downlink transmission may generate some interference with the first downlink transmission (e.g., MIMO inter-user interference). At 445, the first UE 115-c may perform joint demodulation of the downlink transmission based on the indicated co-scheduling information, in accordance with techniques as discussed with reference to FIGS. 2 and 3.

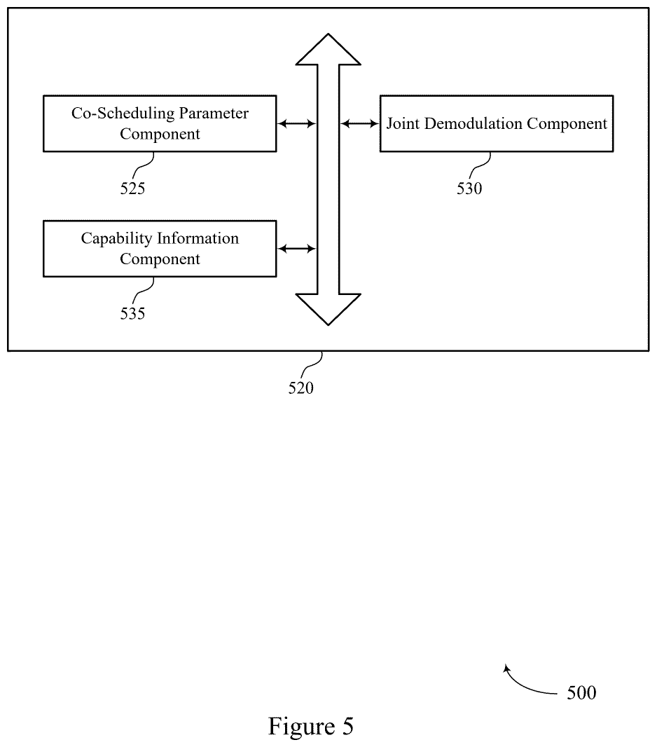

FIG. 5 shows an example 500 of a processing system 520 that supports techniques for MU-MIMO communications with co-scheduling parameter indication. A processing system 520 may be an example of a processing system 140 (such as of a UE 115) and may include a co-scheduling parameter component 525, a joint demodulation component 530, a capability information component 535, or any combination thereof. A processing system 520, or various component thereof, may be an example of means for performing (such as a means for causing a UE 115 to perform) various techniques described herein.

The co-scheduling parameter component 525 may be configured to cause the UE 115 to receive co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit. The joint demodulation component 530 may be configured to cause the UE 115 to receive at least a portion of the first downlink transmission based on a first set of transmission parameters of the first downlink transmission and the second set of transmission parameters indicated by the co-scheduling information for the first resource unit.

In some examples, to support receiving at least the portion of the first downlink transmission, the joint demodulation component 530 may be configured to cause the UE 115 to jointly demodulate the first downlink transmission in accordance with the first set of transmission parameters and the second set of transmission parameters, where the first set of transmission parameters are provided in a scheduling DCI transmission provided to the first UE. In some examples, the frequency domain resources include one or more of PRB resources, PRB group resources, or frequency sub-band resources. In some examples, the time domain resources include one or more OFDM symbols, a set of OFDM symbols, or one or more slots, or any combination thereof. In some examples, the spatial domain resources include one or more co-scheduled spatial layers, one or more groups of co-scheduled spatial layers, or any combination thereof. In some examples, the second set of transmission parameters indicated by the co-scheduling information include one or more of a modulation order, one or more DMRS ports, one or more CDM groups of DMRS ports, DMRS sequence initialization information, or any combination thereof.

In some examples, the co-scheduling information is received via one or more of RRC signaling, a MAC-CE, a non-scheduling unicast DCI transmission, a group common DCI transmission, or a scheduling DCI. In some examples, the co-scheduling information further indicates a time window during which the second set of transmission parameters are used. In some examples, the co-scheduling information further indicates a time periodicity at which the co-scheduling information is repeated.

In some examples, the co-scheduling parameter component 525 may be configured to cause the UE 115 to receive, via one or more RRC messages, information that indicates a set of resource units, including the first resource unit, that can be co-scheduled. In some examples, the co-scheduling parameter component 525 may be configured to cause the UE 115 to receive, via one or more MAC-CEs, the second set of transmission parameters for the set of resource units. In some examples, the co-scheduling parameter component 525 may be configured to cause the UE 115 to receive, via one or more scheduling DCI transmissions, an indication of the first set of transmission parameters and an indication of a presence or absence of co-scheduled layers for the first downlink transmission on a subset of the set of resource units that overlap with the first downlink transmission.

In some examples, the first resource unit is indicated in a RRC message and the second set of transmission parameters is indicated in a MAC-CE, and the scheduling DCI indicates a presence or absence of co-scheduled layers on the first resource unit. In some examples, a set of multiple candidate co-scheduling information profiles are provided via one or more of RRC signaling or a MAC-CE, and the scheduling DCI indicates which profile of the set of multiple candidate co-scheduling information profiles is applied for the first downlink transmission.

In some examples, the capability information component 535 may be configured to cause the UE 115 to transmit capability information that indicates a capability of the first UE to jointly demodulate downlink transmissions in accordance with co-scheduling information. In some examples, the capability information includes one or more of a maximum quantity of co-scheduled layers supported by the first UE, a maximum quantity of frequency domain units supported by the first UE that can have different co-scheduling information, a maximum quantity of time domain units supported by the first UE that can have different co-scheduling information, a maximum quantity of spatial domain units supported by the first UE that can have different co-scheduling information, whether a root DMRS sequence of the second transmission to the second UE can be different than a root DMRS sequence of the first downlink transmission, a maximum quantity of different root DMRS sequences supported by the first UE, a maximum modulation order of a co-scheduled layer, or any combination thereof.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for providing co-scheduling information for one or more resource units, which may enable joint demodulation at a UE for co-scheduled MU-MIMO communications and thereby enhance demodulation and decoding efficiency at the UE while enhancing network efficiency and flexibility for scheduling MU-MIMO communications.

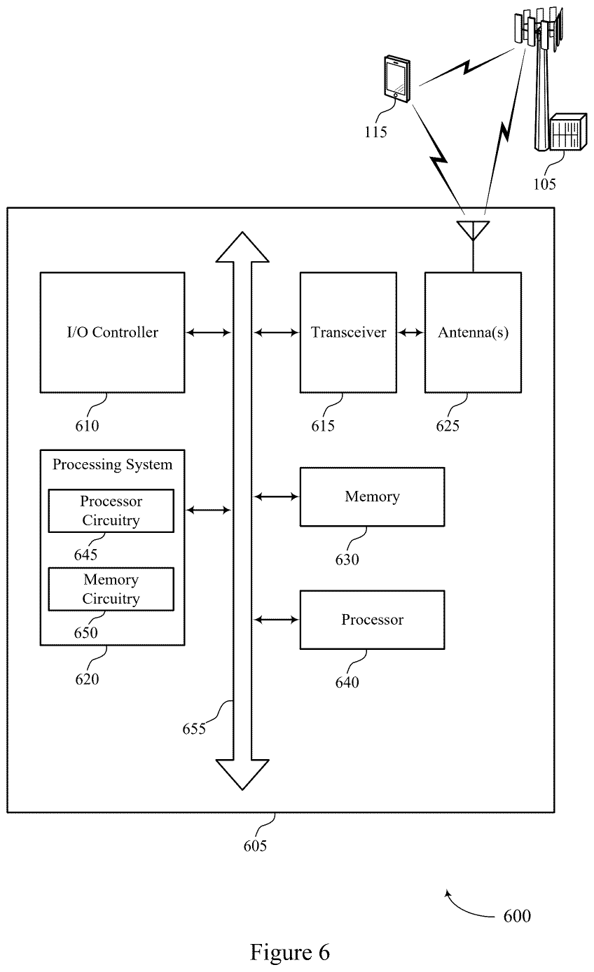

FIG. 6 shows an example of a system 600 including a device 605 that supports techniques for MU-MIMO communications with co-scheduling parameter indication. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 520. For example, the processing system 620 may include processor circuitry 645 and memory circuitry 650 that stores code, and may be configured to cause the device 605 to perform operations that support techniques for MU-MIMO communications with co-scheduling parameter indication. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for providing co-scheduling information for one or more resource units, which may enable joint demodulation at a UE for co-scheduled MU-MIMO communications and thereby enhance demodulation and decoding efficiency at the UE while enhancing network efficiency and flexibility for scheduling MU-MIMO communications.

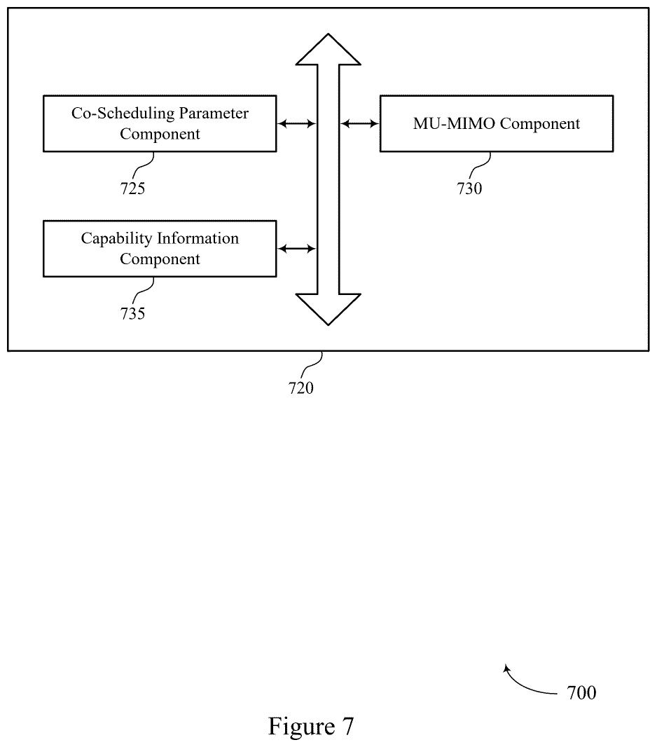

FIG. 7 shows an example 700 of a processing system 720 that supports techniques for MU-MIMO communications with co-scheduling parameter indication. A processing system 720 may be an example of a processing system 145 (such as network entity 105) and may include a co-scheduling parameter component 725, a MU-MIMO component 730, a capability information component 735, or any combination thereof. A processing system 720, or various component thereof, may be an example of means for performing (such as a means for causing a network entity 105 to perform) various techniques described herein.

The co-scheduling parameter component 725 may be configured to cause the network entity 105 to transmit, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit. The MU-MIMO component 730 may be configured to cause the network entity 105 to transmit, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters.

In some examples, the co-scheduling parameter component 725 may be configured to cause the network entity 105 to transmit, to the first UE, a scheduling DCI transmission that indicates the first set of transmission parameters. In some examples, the frequency domain resources include one or more of PRB resources, PRB group resources, or frequency sub-band resources. In some examples, the time domain resources include one or more OFDM symbols, a set of OFDM symbols, or one or more slots, or any combination thereof. In some examples, the spatial domain resources include one or more co-scheduled spatial layers, one or more groups of co-scheduled spatial layers, or any combination thereof. In some examples, the second set of transmission parameters indicated by the co-scheduling information include one or more of a modulation order, one or more DMRS ports, one or more CDM groups of DMRS ports, DMRS sequence initialization information, or any combination thereof.

In some examples, the co-scheduling information is transmitted via one or more of RRC signaling, a MAC-CE, a non-scheduling unicast DCI transmission, a group common DCI transmission, or a scheduling DCI. In some examples, the co-scheduling information further indicates a time window during which the second set of transmission parameters are used. In some examples, the co-scheduling information further indicates a time periodicity at which the co-scheduling information is repeated.

In some examples, the co-scheduling parameter component 725 may be configured to cause the network entity 105 to transmit to the first UE, via one or more RRC messages, information that indicates a set of resource units, including the first resource unit, that can be co-scheduled. In some examples, the co-scheduling parameter component 725 may be configured to cause the network entity 105 to transmit to the first UE, via one or more MAC-CEs, the second set of transmission parameters for the set of resource units. In some examples, the co-scheduling parameter component 725 may be configured to cause the network entity 105 to transmit to the first UE, via one or more scheduling DCI transmissions, an indication of the first set of transmission parameters and an indication of a presence or absence of co-scheduled layers for the first downlink transmission on a subset of the set of resource units that overlap with the first downlink transmission.

In some examples, the first resource unit is indicated in a RRC message and the second set of transmission parameters is indicated in a MAC-CE, and the scheduling DCI indicates a presence or absence of co-scheduled layers on the first resource unit. In some examples, a set of multiple candidate co-scheduling information profiles are provided via one or more of RRC signaling or a MAC-CE, and the scheduling DCI indicates which profile of the set of multiple candidate co-scheduling information profiles is applied for the first downlink transmission.

In some examples, the capability information component 735 may be configured to cause the network entity 105 to receive, from the first UE, capability information that indicates a capability of the first UE to jointly demodulate downlink transmissions in accordance with co-scheduling information. In some examples, the capability information includes one or more of a maximum quantity of co-scheduled layers supported by the first UE, a maximum quantity of frequency domain units supported by the first UE that can have different co-scheduling information, a maximum quantity of time domain units supported by the first UE that can have different co-scheduling information, a maximum quantity of spatial domain units supported by the first UE that can have different co-scheduling information, whether a root DMRS sequence of the second transmission to the second UE can be different than a root DMRS sequence of the first downlink transmission, a maximum quantity of different root DMRS sequences supported by the first UE, a maximum modulation order of a co-scheduled layer, or any combination thereof.

A processing system 720 may include or be an example of one or more chips, SoCs, chipsets, packages, components, or devices that individually or collectively constitute or include a processing system. A processing system 720 may interface with other components of a network entity 105. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a network entity 105). Operations described herein with reference to the processing system 720, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 720 for operation in a processing system 720 as described herein, the processing system 720 may support techniques for providing co-scheduling information for one or more resource units, which may enable joint demodulation at a UE for co-scheduled MU-MIMO communications and thereby enhance demodulation and decoding efficiency at the UE while enhancing network efficiency and flexibility for scheduling MU-MIMO communications.

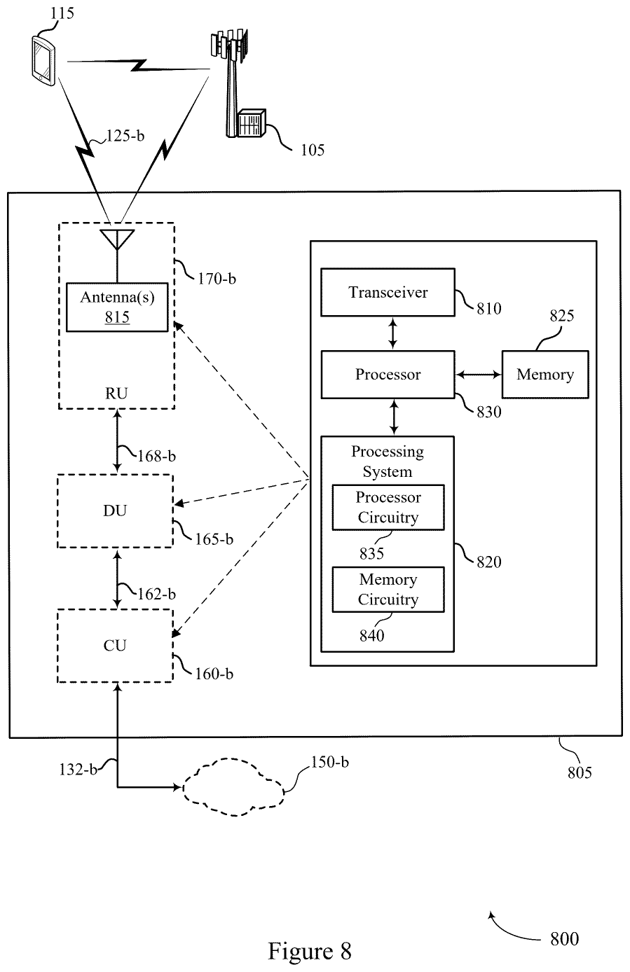

FIG. 8 shows an example of a system 800 including a device 805 that supports techniques for MU-MIMO communications with co-scheduling parameter indication. The device 805 may communicate (such as via one or more wired interfaces or one or more wireless interfaces) with other network devices or network equipment such as a core network 150-b, other network entities 105, UEs 115, or any combination thereof. The device 805 may include components for transmitting and receiving communication, which may include a processing system 820, a transceiver 810, antenna(s) 815, a memory 825, and a processor 830. Components of the device 805 may be coupled (such as operatively, communicatively, functionally, electronically, electrically, in electronic communication) via one or more interfaces.

The transceiver 810 may communicate bi-directionally with another transceiver via wired or wireless links, and may support transmission operations, reception operations, or both, as described herein. The transceiver 810 may include a modem to modulate and demodulate signals, to provide the modulated signals for transmission (such as via antenna(s) 815, via a wired interface), and to demodulate received signals (such as received via antenna(s) 815, received via a wired interface). The transceiver 810 may be operable to support communication via one or more communication links (such as a communication link 125-b, a backhaul link 132-b, a midhaul link 162-b, fronthaul link 168-b).

The processor 830 may be a general-purpose processing component that supports various operations (such as applications) of the device 805. The memory 825 may be a general-purpose storage component that stores code executable by the processor 830. Such code may include instructions that, when executed by the processor 830, cause the device 805 to perform various functions (such as to support an application of the device 805).

For examples in which the device 805 is a network entity 105 in a disaggregated architecture, one or more components of the device 805 may be located at one or more of a CU 160-b, a DU 165-b, or an RU 170-b, one or more of which may include aspects of the processing system 820, the processor 830, the memory 825, or the transceiver 810. Functions of the device 805 may be performed at different components or an operation may be divided between different components (such as different functions being supported by aspects of the CU 160-b, the DU 165-b, or the RU 170-b, the transceiver 810, the processor 830, the memory 825, the processing system 820, or any combination thereof). For example, the processing system 820 may be a component of one or more of the CU 160-b, the DU 165-b, or the RU 170-b. In some examples, interfaces between components of device 805 (such as CU 160-b, DU 165-b, RU 170-b) may support communication at a protocol layer or between protocol layers of a protocol stack.

In some examples, the processing system 820 may manage aspects of communication with the core network 150-b (such as via a backhaul link 132). For example, the processing system 820 may manage the transfer of data communication for UEs 115 with a gateway of the core network 150-b. In some examples, the processing system 820 may manage communication with one or more other network entities 105 and may include a controller or scheduler for controlling communication with UEs 115 (such as in cooperation with the one or more other network entities 105). In some examples, the processing system 820 may support an interface (such as X2 interface, Xn interface) to provide communication between network entities 105.

The processing system 820 may be an example of a processing system 145 or a processing system 720. For example, the processing system 820 may include processor circuitry 835 and memory circuitry 840 that stores code, and the processing system 820 may be configured to cause the device 805 to perform operations that support techniques for MU-MIMO communications with co-scheduling parameter indication. Although the processing system 820 is illustrated as a separate component, which may involve a separate chip, chipset, or other module, in some implementations, one or more functions described with reference to the processing system 820 may be supported by or performed by a transceiver 810, antenna(s) 815, a processor 830, memory 825, or any combination thereof, such that a processing system 820 may include one or more of a transceiver 810, antenna(s) 815, a processor 830, memory 825, or any combination thereof. Further, processor circuitry 835 and memory circuitry 840 each may be implemented at the device 805 in accordance with an aggregated architecture, or the processor circuitry 835 and the memory circuitry 840 may be implemented at one or more of a CU 160-b, a DU 165-b, or an RU 170-b in accordance with a disaggregated architecture.

By including or configuring the processing system 820 for operation in the device 805 as described herein, may support techniques for providing co-scheduling information for one or more resource units, which may enable joint demodulation at a UE for co-scheduled MU-MIMO communications and thereby enhance demodulation and decoding efficiency at the UE while enhancing network efficiency and flexibility for scheduling MU-MIMO communications.

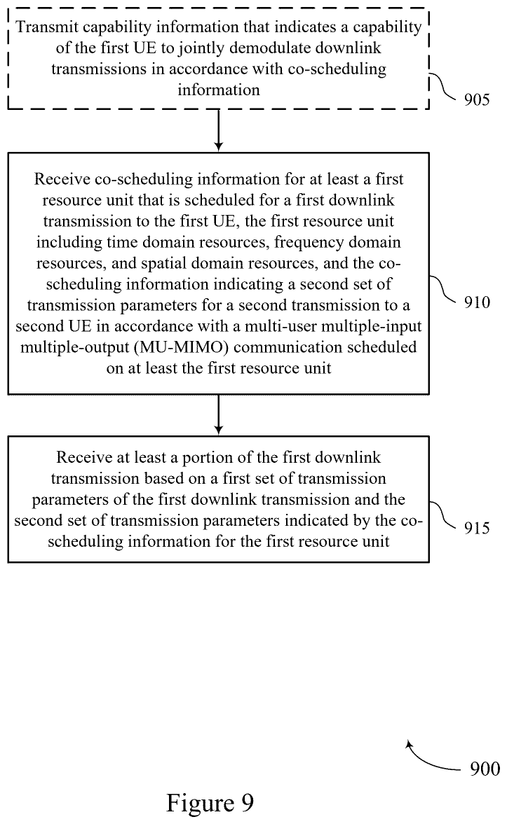

FIG. 9 shows an example of a method 900 that supports techniques for MU-MIMO communications with co-scheduling parameter indication. Operations of the method 900 may be performed by a UE or its components (such as using a processing system configured to cause the UE 115 to perform one or more of the operations) as described herein.

Optionally, at 905, the method may include transmitting capability information that indicates a capability of the first UE to jointly demodulate downlink transmissions in accordance with co-scheduling information. In some examples, aspects of the operations of 905 may be performed by a capability information component 535.

At 910, the method may include receiving co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit. In some examples, aspects of the operations of 910 may be performed by a co-scheduling parameter component 525.

At 915, the method may include receiving at least a portion of the first downlink transmission based on a first set of transmission parameters of the first downlink transmission and the second set of transmission parameters indicated by the co-scheduling information for the first resource unit. In some examples, aspects of the operations of 915 may be performed by a joint demodulation component 530.

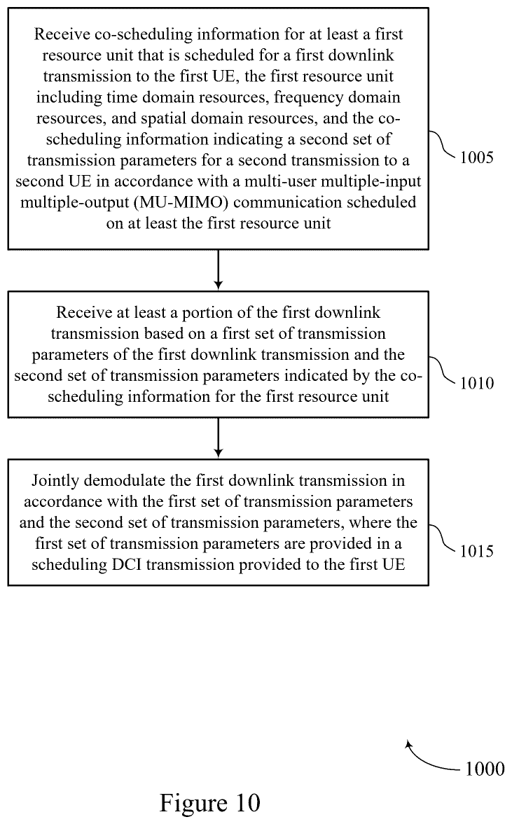

FIG. 10 shows an example of a method 1000 that supports techniques for MU-MIMO communications with co-scheduling parameter indication. Operations of the method 1000 may be performed by a UE or its components (such as using a processing system configured to cause the UE 115 to perform one or more of the operations) as described herein.

At 1005, the method may include receiving co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit. In some examples, aspects of the operations of 1005 may be performed by a co-scheduling parameter component 525.

At 1010, the method may include receiving at least a portion of the first downlink transmission based on a first set of transmission parameters of the first downlink transmission and the second set of transmission parameters indicated by the co-scheduling information for the first resource unit. In some examples, aspects of the operations of 1010 may be performed by a joint demodulation component 530.

At 1015, the method may include jointly demodulating the first downlink transmission in accordance with the first set of transmission parameters and the second set of transmission parameters, where the first set of transmission parameters are provided in a scheduling DCI transmission provided to the first UE. In some examples, aspects of the operations of 1015 may be performed by a joint demodulation component 530.

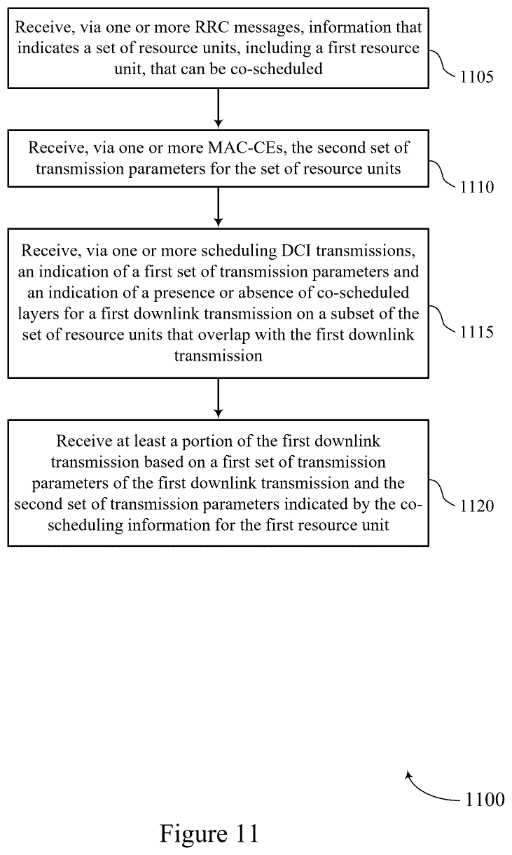

FIG. 11 shows an example of a method 1100 that supports techniques for MU-MIMO communications with co-scheduling parameter indication. Operations of the method 1100 may be performed by a UE or its components (such as using a processing system configured to cause the UE 115 to perform one or more of the operations) as described herein.

At 1105, the method may include receiving, via one or more RRC messages, information that indicates a set of resource units, including a first resource unit, that can be co-scheduled. In some examples, aspects of the operations of 1105 may be performed by a co-scheduling parameter component 525.

At 1110, the method may include receiving, via one or more MAC-CEs, the second set of transmission parameters for the set of resource units. In some examples, aspects of the operations of 1110 may be performed by a co-scheduling parameter component 525. In some aspects, the second set of transmission parameters are for a co-scheduled second transmission to a second UE in accordance with a MU-MIMO communication scheduled on at least the first resource unit.

At 1115, the method may include receiving, via one or more scheduling DCI transmissions, an indication of a first set of transmission parameters and an indication of a presence or absence of co-scheduled layers for a first downlink transmission on a subset of the set of resource units that overlap with the first downlink transmission. In some examples, aspects of the operations of 1115 may be performed by a co-scheduling parameter component 525.

At 1120, the method may include receiving at least a portion of the first downlink transmission based on a first set of transmission parameters of the first downlink transmission and the second set of transmission parameters indicated by the co-scheduling information for the first resource unit. In some examples, aspects of the operations of 1120 may be performed by a joint demodulation component 530.

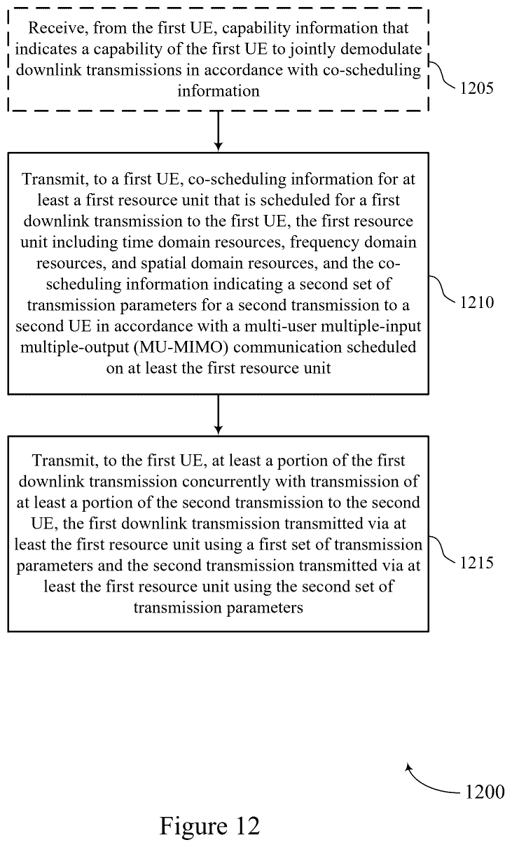

FIG. 12 shows an example of a method 1200 that supports techniques for MU-MIMO communications with co-scheduling parameter indication. Operations of the method 1200 may be performed by a network entity 105 or its components (such as using a processing system configured to cause the network entity to perform one or more operations) as described herein.

Optionally, at 1205, the method may include receiving, from the first UE, capability information that indicates a capability of the first UE to jointly demodulate downlink transmissions in accordance with co-scheduling information. In some examples, aspects of the operations of 1205 may be performed by a capability information component 735.

At 1210, the method may include transmitting, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit. In some examples, aspects of the operations of 1210 may be performed by a co-scheduling parameter component 725.

At 1215, the method may include transmitting, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters. In some examples, aspects of the operations of 1215 may be performed by a MU-MIMO component 730.

Implementation examples are described in the following numbered clauses:

Aspect 1: A method for wireless communications at a first UE, comprising: receiving co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit; and receiving at least a portion of the first downlink transmission based at least in part on a first set of transmission parameters of the first downlink transmission and the second set of transmission parameters indicated by the co-scheduling information for the first resource unit.

Aspect 2: The method of aspect 1, wherein receiving at least the portion of the first downlink transmission comprises: jointly demodulating the first downlink transmission in accordance with the first set of transmission parameters and the second set of transmission parameters, wherein the first set of transmission parameters are provided in a scheduling DCI transmission provided to the first UE.

Aspect 3: The method of any of aspects 1 through 2, wherein the frequency domain resources include one or more of PRB resources, PRB group resources, or frequency sub-band resources.

Aspect 4: The method of any of aspects 1 through 3, wherein the time domain resources include one or more OFDM symbols, a set of OFDM symbols, or one or more slots, or any combination thereof.

Aspect 5: The method of any of aspects 1 through 4, wherein the spatial domain resources include one or more co-scheduled spatial layers, one or more groups of co-scheduled spatial layers, or any combination thereof.

Aspect 6: The method of any of aspects 1 through 5, wherein the second set of transmission parameters indicated by the co-scheduling information include one or more of a modulation order, one or more DMRS ports, one or more CDM groups of DMRS ports, DMRS sequence initialization information, or any combination thereof.

Aspect 7: The method of any of aspects 1 through 6, wherein the co-scheduling information is received via one or more of RRC signaling, a MAC-CE, a non-scheduling unicast DCI transmission, a group common DCI transmission, or a scheduling DCI.

Aspect 8: The method of aspect 7, wherein the co-scheduling information further indicates a time window during which the second set of transmission parameters are used.

Aspect 9: The method of any of aspects 7 through 8, wherein the co-scheduling information further indicates a time periodicity at which the co-scheduling information is repeated.

Aspect 10: The method of any of aspects 7 through 9, further comprising: receiving, via one or more RRC messages, information that indicates a set of resource units, including the first resource unit, that can be co-scheduled; receiving, via one or more MAC-CEs, the second set of transmission parameters for the set of resource units; and receiving, via one or more scheduling DCI transmissions, an indication of the first set of transmission parameters and an indication of a presence or absence of co-scheduled layers for the first downlink transmission on a subset of the set of resource units that overlap with the first downlink transmission.

Aspect 11: The method of any of aspects 7 through 10, wherein the first resource unit is indicated in a RRC message and the second set of transmission parameters is indicated in a MAC-CE, and the scheduling DCI indicates a presence or absence of co-scheduled layers on the first resource unit.

Aspect 12: The method of any of aspects 7 through 11, wherein a plurality of candidate co-scheduling information profiles are provided via one or more of RRC signaling or a MAC-CE, and the scheduling DCI indicates which profile of the plurality of candidate co-scheduling information profiles is applied for the first downlink transmission.

Aspect 13: The method of any of aspects 1 through 12, further comprising: transmitting capability information that indicates a capability of the first UE to jointly demodulate downlink transmissions in accordance with co-scheduling information.

Aspect 14: The method of aspect 13, wherein the capability information includes one or more of a maximum quantity of co-scheduled layers supported by the first UE, a maximum quantity of frequency domain units supported by the first UE that can have different co-scheduling information, a maximum quantity of time domain units supported by the first UE that can have different co-scheduling information, a maximum quantity of spatial domain units supported by the first UE that can have different co-scheduling information, whether a root DMRS sequence of the second transmission to the second UE can be different than a root DMRS sequence of the first downlink transmission, a maximum quantity of different root DMRS sequences supported by the first UE, a maximum modulation order of a co-scheduled layer, or any combination thereof.

Aspect 15: A method for wireless communications at a network entity, comprising: transmitting, to a first UE, co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a MU-MIMO communication scheduled on at least the first resource unit; and transmitting, to the first UE, at least a portion of the first downlink transmission concurrently with transmission of at least a portion of the second transmission to the second UE, the first downlink transmission transmitted via at least the first resource unit using a first set of transmission parameters and the second transmission transmitted via at least the first resource unit using the second set of transmission parameters.

Aspect 16: The method of aspect 15, further comprising: transmitting, to the first UE, a scheduling DCI transmission that indicates the first set of transmission parameters.

Aspect 17: The method of any of aspects 15 through 16, wherein the frequency domain resources include one or more of PRB resources, PRB group resources, or frequency sub-band resources.

Aspect 18: The method of any of aspects 15 through 17, wherein the time domain resources include one or more OFDM symbols, a set of OFDM symbols, or one or more slots, or any combination thereof.

Aspect 19: The method of any of aspects 15 through 18, wherein the spatial domain resources include one or more co-scheduled spatial layers, one or more groups of co-scheduled spatial layers, or any combination thereof.

Aspect 20: The method of any of aspects 15 through 19, wherein the second set of transmission parameters indicated by the co-scheduling information include one or more of a modulation order, one or more DMRS ports, one or more CDM groups of DMRS ports, DMRS sequence initialization information, or any combination thereof.

Aspect 21: The method of any of aspects 15 through 20, wherein the co-scheduling information is transmitted via one or more of RRC signaling, a MAC-CE, a non-scheduling unicast DCI transmission, a group common DCI transmission, or a scheduling DCI.

Aspect 22: The method of aspect 21, wherein the co-scheduling information further indicates a time window during which the second set of transmission parameters are used.

Aspect 23: The method of any of aspects 21 through 22, wherein the co-scheduling information further indicates a time periodicity at which the co-scheduling information is repeated.

Aspect 24: The method of any of aspects 21 through 23, further comprising: transmitting to the first UE, via one or more RRC messages, information that indicates a set of resource units, including the first resource unit, that can be co-scheduled; transmitting to the first UE, via one or more MAC-CEs, the second set of transmission parameters for the set of resource units; and transmitting to the first UE, via one or more scheduling DCI transmissions, an indication of the first set of transmission parameters and an indication of a presence or absence of co-scheduled layers for the first downlink transmission on a subset of the set of resource units that overlap with the first downlink transmission.

Aspect 25: The method of any of aspects 21 through 24, wherein the first resource unit is indicated in a RRC message and the second set of transmission parameters is indicated in a MAC-CE, and the scheduling DCI indicates a presence or absence of co-scheduled layers on the first resource unit.

Aspect 26: The method of any of aspects 21 through 25, wherein a plurality of candidate co-scheduling information profiles are provided via one or more of RRC signaling or a MAC-CE, and the scheduling DCI indicates which profile of the plurality of candidate co-scheduling information profiles is applied for the first downlink transmission.

Aspect 27: The method of any of aspects 15 through 26, further comprising: receiving, from the first UE, capability information that indicates a capability of the first UE to jointly demodulate downlink transmissions in accordance with co-scheduling information.

Aspect 28: The method of aspect 27, wherein the capability information includes one or more of a maximum quantity of co-scheduled layers supported by the first UE, a maximum quantity of frequency domain units supported by the first UE that can have different co-scheduling information, a maximum quantity of time domain units supported by the first UE that can have different co-scheduling information, a maximum quantity of spatial domain units supported by the first UE that can have different co-scheduling information, whether a root DMRS sequence of the second transmission to the second UE can be different than a root DMRS sequence of the first downlink transmission, a maximum quantity of different root DMRS sequences supported by the first UE, a maximum modulation order of a co-scheduled layer, or any combination thereof.

Aspect 29: A first UE for wireless communications, comprising a processing system that includes processor circuitry and memory circuitry that stores code, the processing system configured to cause the first UE to perform a method of any of aspects 1 through 14.

Aspect 30: A first UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising a processing system that includes processor circuitry and memory circuitry that stores code, the processing system configured to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
a processing system that includes processor circuitry and memory circuitry that stores code, the processing system configured to cause the first UE to:
receive co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a multi-user multiple-input multiple-output (MU-MIMO) communication scheduled on at least the first resource unit; and
receive at least a portion of the first downlink transmission based at least in part on a first set of transmission parameters of the first downlink transmission and the second set of transmission parameters indicated by the co-scheduling information for the first resource unit.

2. The first UE of claim 1, wherein, to receive at least the portion of the first downlink transmission, the processing system is configured to cause the first UE to:
jointly demodulate the first downlink transmission in accordance with the first set of transmission parameters and the second set of transmission parameters, wherein the first set of transmission parameters are provided in a scheduling downlink control information (DCI) transmission provided to the first UE.

3. The first UE of claim 1, wherein:
the frequency domain resources include one or more of physical resource block (PRB) resources, PRB group resources, or frequency sub-band resources.

4. The first UE of claim 1, wherein the time domain resources include one or more orthogonal frequency division multiplexing (OFDM) symbols, a set of OFDM symbols, or one or more slots, or any combination thereof.

5. The first UE of claim 1, wherein the spatial domain resources include one or more co-scheduled spatial layers, one or more groups of co-scheduled spatial layers, or any combination thereof.

6. The first UE of claim 1, wherein the second set of transmission parameters indicated by the co-scheduling information include one or more of a modulation order, one or more demodulation reference signal (DMRS) ports, one or more code division multiplexing (CDM) groups of DMRS ports, DMRS sequence initialization information, or any combination thereof.

7. The first UE of claim 1, wherein the co-scheduling information is received via one or more of radio resource control (RRC) signaling, a medium access control (MAC) control element (CE), a non-scheduling unicast downlink control information (DCI) transmission, a group common DCI transmission, or a scheduling DCI.

8. The first UE of claim 7, wherein the co-scheduling information further indicates a time window during which the second set of transmission parameters are used.

9. The first UE of claim 7, wherein the co-scheduling information further indicates a time periodicity at which the co-scheduling information is repeated.

10. The first UE of claim 7, wherein the processing system is further configured to cause the first UE to:
receive, via one or more RRC messages, information that indicates a set of resource units, including the first resource unit, that can be co-scheduled;
receive, via one or more MAC-CEs, the second set of transmission parameters for the set of resource units; and
receive, via one or more scheduling DCI transmissions, an indication of the first set of transmission parameters and an indication of a presence or absence of co-scheduled layers for the first downlink transmission on a subset of the set of resource units that overlap with the first downlink transmission.

11. The first UE of claim 7, wherein the first resource unit is indicated in a RRC message and the second set of transmission parameters is indicated in a MAC-CE, and the scheduling DCI indicates a presence or absence of co-scheduled layers on the first resource unit.

12. The first UE of claim 7, wherein a plurality of candidate co-scheduling information profiles are provided via one or more of RRC signaling or a MAC-CE, and the scheduling DCI indicates which profile of the plurality of candidate co-scheduling information profiles is applied for the first downlink transmission.

13. The first UE of claim 1, wherein the processing system is further configured to cause the first UE to:
transmit capability information that indicates a capability of the first UE to jointly demodulate downlink transmissions in accordance with co-scheduling information.

14. The first UE of claim 13, wherein the capability information includes one or more of a maximum quantity of co-scheduled layers supported by the first UE, a maximum quantity of frequency domain units supported by the first UE that can have different co-scheduling information, a maximum quantity of time domain units supported by the first UE that can have different co-scheduling information, a maximum quantity of spatial domain units supported by the first UE that can have different co-scheduling information, whether a root demodulation reference signal (DMRS) sequence of the second transmission to the second UE can be different than a root DMRS sequence of the first downlink transmission, a maximum quantity of different root DMRS sequences supported by the first UE, a maximum modulation order of a co-scheduled layer, or any combination thereof.

15. A method for wireless communications at a first user equipment (UE), comprising:
receiving co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a multi-user multiple-input multiple-output (MU-MIMO) communication scheduled on at least the first resource unit; and
receiving at least a portion of the first downlink transmission based at least in part on a first set of transmission parameters of the first downlink transmission and the second set of transmission parameters indicated by the co-scheduling information for the first resource unit.

16. The method of claim 15, wherein receiving at least the portion of the first downlink transmission comprises:
jointly demodulating the first downlink transmission in accordance with the first set of transmission parameters and the second set of transmission parameters, wherein the first set of transmission parameters are provided in a scheduling downlink control information (DCI) transmission provided to the first UE.

17. The method of claim 15, wherein:
the frequency domain resources include one or more of physical resource block (PRB) resources, PRB group resources, or frequency sub-band resources;
the time domain resources include one or more orthogonal frequency division multiplexing (OFDM) symbols, a set of OFDM symbols, or one or more slots, or any combination thereof; and
the spatial domain resources include one or more co-scheduled spatial layers, one or more groups of co-scheduled spatial layers, or any combination thereof.

18. A non-transitory computer-readable medium storing code for wireless communications, the code comprising instructions executable by one or more processors to:
receive, at a first user equipment (UE), co-scheduling information for at least a first resource unit that is scheduled for a first downlink transmission to the first UE, the first resource unit including time domain resources, frequency domain resources, and spatial domain resources, and the co-scheduling information indicating a second set of transmission parameters for a second transmission to a second UE in accordance with a multi-user multiple-input multiple-output (MU-MIMO) communication scheduled on at least the first resource unit; and
receive at least a portion of the first downlink transmission based at least in part on a first set of transmission parameters of the first downlink transmission and the second set of transmission parameters indicated by the co-scheduling information for the first resource unit.

19. The non-transitory computer-readable medium of claim 18, wherein the second set of transmission parameters indicated by the co-scheduling information include one or more of a modulation order, one or more demodulation reference signal (DMRS) ports, one or more code division multiplexing (CDM) groups of DMRS ports, DMRS sequence initialization information, or any combination thereof.

20. The non-transitory computer-readable medium of claim 18, wherein the co-scheduling information is received via one or more of radio resource control (RRC) signaling, a medium access control (MAC) control element (CE), a non-scheduling unicast downlink control information (DCI) transmission, a group common DCI transmission, or a scheduling DCI.
